(19) United States
(12) Patent Application Publication
(10) Pub. No.: US 2015/0012940 A1
(43) Pub. Date: Jan. 8, 2015

(54) CONTENT CONTROL APPARATUS AND METHOD OF OPERATING CONTENT CONTROL APPARATUS

(71) Applicant: LG Electronics Inc., Seoul (KR)

(72) Inventor: Hunkyo JUNG, Pyeongtaek-si (KR)

(73) Assignee: LG ELECTRONICS INC., Seoul (KR)

(21) Appl. No.: 14/167,805

(22) Filed: Jan. 29, 2014

(30) Foreign Application Priority Data
Jul. 8, 2013 (KR) 10-2013-0079880

(51) Int. Cl. H04N 21/485

(52) U.S. Cl. CPC H04N 21/485
USPC 725/37

(57) ABSTRACT

According to one embodiment, a content control apparatus includes: a display configured to display content items; and a controller configured to: generate a grid for setting regions when an editing event occurs; display the grid on the display, such that each content item is displayed at a region of the regions; automatically generate a folder when it is determined that one or more of the regions are selected, wherein one or more of the content items are displayed at the selected one or more regions; store the one or more content items in the generated folder; and automatically retrieve the stored one or more content items from the generated folder and concurrently delete the generated folder when an event for retrieving the stored content item(s) from the generated folder occurs. The controller is further configured to display information regarding folder editing on the display unit when the grid is selected.

### CROSS REFERENCE TO RELATED APPLICATION(S)

This application claims the benefit of earlier filing date and right of priority to Korean Patent Application No. 10-2013-0079880, filed on Jul. 8, 2013, the contents of which are incorporated by reference herein in their entirety.

### TECHNICAL FIELD

Embodiments of the present invention relate to a content control apparatus and a method of operating a content control apparatus.

### BACKGROUND

In general, video display devices include both a device for receiving and displaying a broadcast or recording and reproducing video and a device for recording and reproducing audio. For example, such video display devices may include a television, a computer monitor, a projector, a tablet, etc. As functionalities of video display devices have become more diverse, they have been implemented as multimedia players providing more complicated capabilities such as capturing images or video, playing games, receiving broadcast signals, etc., as well as reproducing music or video files.

A plurality of icons (or content items) for executing application programs may be displayed on a background screen (or an idle screen) of a video display device. When an icon is selected, an application linked to the selected icon is executed.

### SUMMARY

According to one embodiment, a content control apparatus includes: a display unit configured to display a plurality of content items; and a controller configured to: generate a grid for setting a plurality of regions when an editing event occurs; display the grid on the display unit, such that each of the plurality of content items is displayed at a region of the plurality of regions; automatically generate a folder when it is determined that one or more regions of the plurality of regions are selected, wherein one or more content items of the plurality of content items are displayed at the selected one or more regions; store the one or more content items in the generated folder; and automatically retrieve the stored one or more content items from the generated folder and concurrently delete the generated folder when an event for retrieving the stored one or more content items from the generated folder occurs. The controller is further configured to display information regarding folder editing on the display unit when the grid is selected.

The controller may be further configured to: detect a common category of the one or more content items stored in the generated folder; and automatically set a title corresponding to the common category as a name of the generated folder.

The controller may be further configured to: detect categories of the one or more content items stored in the generated folder; select a category having a largest detection occurrence from among the detected categories; and automatically set a title corresponding to the selected category as a name of the generated folder.

The controller may be further configured to automatically arrange a display of the retrieved one or more content items on the display unit.

The information may include user instructions regarding setting a region for selecting content items, generating the folder, and deleting the folder.

When a content item is selected from the plurality of content items displayed on the display unit and a pre-set event for generating the folder occurs, the controller may generate the folder and display the generated folder at a display position of the selected content item, and stores the selected content item in the generated folder.

When the one or more content items are stored in the generated folder, the controller may display one or more representative images, each of the one or more representative images representing a respective one of the one or more content items, such that portions of the one or more representative images overlap.

The controller may change a display position of each of the one or more representative images according to a user input.

When a particular representative image is selected from the one or more representative images, the controller may reproduce a preview image of content corresponding to the selected particular representative image on the generated folder.

When the controller receives a signal for requesting execution of the content corresponding to the selected particular representative image, the controller may execute the content corresponding to the selected particular representative image in response to the received signal.

According to one embodiment, a method of operating a content control apparatus includes displaying, by a display unit of the content control apparatus, a plurality of content items; generating a grid for setting a plurality of regions when an editing event occurs; displaying, by the display unit, the generated grid such that each of the plurality of content items is displayed at a region of the plurality of regions; automatically generating a folder when it is determined that one or more regions of the plurality of regions are selected, wherein one or more content items of the plurality of content items are displayed at the selected one or more regions; storing the one or more content items in the generated folder; automatically retrieving the stored one or more content items from the generated folder when an event for retrieving the stored one or more content items from the generated folder occurs; and displaying, by the display unit, information regarding folder editing when the grid is selected.

According to one embodiment, a content control apparatus includes: a display unit configured to display a plurality of content items; and a controller configured to: automatically generate a folder when it is determined that a region including one or more content items among the displayed plurality of content items is selected; store the one or more content items included in the generated folder; detect categories of the stored one or more content items; determine a name of the generated folder based on the detected categories; automatically display the determined name of the folder on the generated folder; arrange the categories of the stored one or more content items according to priority; display titles corresponding to the arranged categories on the generated folder; and, when a title of the titles corresponding to the arranged categories is selected, change the name of the generated folder to the selected title.

The controller may be further configured to set a category having a highest detection occurrence or a highest frequency of usage from among the detected categories as the name of the generated folder

The controller may be further configured to arrange the categories of the stored one or more content items in order, starting from a category having a highest detection occurrence or a highest frequency of usage; determine the arranged categories as folder names; and display a folder name list including the folder names together with the determined name of the generated folder.

The controller may be further configured to: when it is determined that a region for selecting a particular content item of the plurality of content items and a particular folder is selected, automatically generate a new folder, store the particular content item and the particular folder in the generated new folder, and automatically set a category having a highest frequency of usage or having a highest detection occurrence from among the categories of the stored content items and the particular folder, as a name of the generated new folder.

The controller may be further configured to: when it is determined that a region for selecting a first folder and a second folder is selected, automatically generate a new folder, store the first folder and the second folder in the generated new folder, and automatically set a category having a highest frequency of usage or having a highest detection occurrence from among the categories of content items stored in the first folder and the second folder, as a name of the generated new folder.

Further scope of applicability of features of embodiments of the present invention will become apparent from the detailed description provided hereinafter. However, it should be understood that the detailed description and specific examples, while describing particular embodiments of the present invention, are provided by way of illustration only. Based on the detail description, various changes and modifications within the spirit and scope of the present invention will become apparent to those skilled in the art.

### BRIEF DESCRIPTION OF THE DRAWINGS

Embodiments of the present invention will become more fully understood from the detailed description given hereinbelow and the accompanying drawings, which are given by illustration only, and thus do not limit the present invention, wherein:

FIG. 1 is a block diagram of a video display device according to one embodiment, which interfaces with an external input device;

FIG. 2 is a block diagram of an external input device according to one embodiment;

FIG. 3 illustrates an interaction between the video display device and the external input device according to one embodiment;

FIG. 4 is a flow chart illustrating a method of operating a content control apparatus (or content control method) according to one embodiment;

FIG. 5 illustrates an example of selection of content items;

FIG. 6 illustrates another example of selection of content items;

FIG. 7A illustrates an example of a generated folder according to one embodiment;

FIG. 7B illustrates another example of a generated folder according to one embodiment;

FIG. 8 illustrates deletion of a generated folder according to one embodiment;

FIGS. 9 and 10 illustrate generation of a folder when a single content item is selected according to one embodiment;

FIG. 11 is a flow chart illustrating a method of operating a content control apparatus (or content control method) according to one embodiment;

FIG. 12 illustrates images displayed on a folder according to one embodiment; and

FIGS. 13 and 14 illustrate executing content within a folder according to one embodiment.

### DETAILED DESCRIPTION

Hereinafter, embodiments of the present invention will be described in detail with reference to the accompanying drawings. If a detailed explanation of a related known function or construction would unnecessarily distract from features and aspects of the present invention, such explanation will be omitted but would be understood by those skilled in the art. Also, similar reference numerals are used for similar parts throughout the specification.

According to embodiments of the present invention, a video display device may include a device for receiving and displaying a broadcast or recording and reproducing a video and a device for recording and reproducing audio.

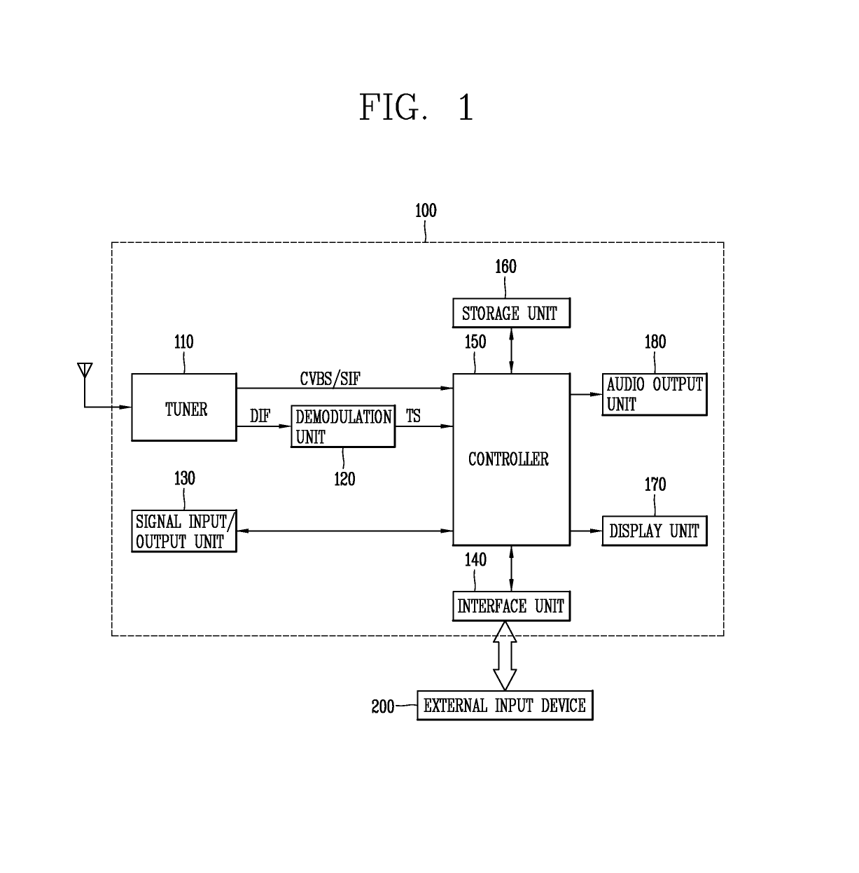

FIG. 1 is a block diagram of a video display device 100 according to one embodiment, that interfaces with an external input device 200. The video display device 100 may include a tuner 110, a demodulation unit 120, a signal input/output unit 130, an interface unit 140, a controller 150, a storage unit 160, a display unit 170, and an audio output unit 180. The external input device 200 may be a device separate from the video display device 100, or may be a component of the video display device 100.

With reference to FIG. 1, the tuner 110 selects an radio frequency (RF) broadcast signal corresponding to a channel selected by a user from among RF broadcast signals received through an antenna, and converts the selected RF broadcast signal into an intermediate frequency (IF) signal or a baseband video/audio signal. For example, when the RF broadcast signal is a digital broadcast signal, the tuner 110 converts the RF broadcast signal into a digital IF (DIF) signal. When the RF broadcast signal is an analog broadcast signal, the tuner 110 converts the RF broadcast signal into an analog baseband video/audio signal (CVBS/SIF). According to one embodiment, the tuner 110 may be a hybrid tuner capable of processing a digital broadcast signal and an analog broadcast signal.

The digital IF (DIF) signal output from the tuner 110 may be input to the demodulation unit 120, and the analog baseband video/audio signal (CVBS/SIF) output from the tuner 110 may be input to the controller 150.

The tuner 120 may receive an RF broadcast signal of a single carrier according to an advanced television systems committee (ATSC) scheme. The tuner 120 may receive RF broadcast signals of a plurality of carriers according to a digital video broadcasting (DVB) scheme.

In the embodiment of FIG. 1, a single tuner 110 is illustrated. However, embodiments of the present invention are not limited thereto, and the video display device 100 may include a plurality of tuners. According to one embodiment, the video display device 100 may include a first tuner and a second tuner. In this case, the first tuner may receive a first RF broadcast signal corresponding to a broadcast signal selected by a user, and the second tuner may sequentially or periodically receive a second RF broadcast signal corresponding to a stored broadcast signal. The first tuner and the second tuner may each convert an RF broadcast signal into a digital IF (DIF) signal or an analog baseband video/audio signal (CVBS/SIF).

The demodulation unit 120 may receive the converted digital IF (DIF) signal from the tuner 110 and perform a demodulation operation on the received signal.

When the digital IF signal (DIF) output from the tuner 110 is based on an ATSC scheme, the demodulation unit 120 may perform 8-vestigal side band (8-VSB) demodulation. 8-VSB demodulation is a demodulation based on VSB of single carrier amplitude modulation using a national television system committee (NTSC) frequency band. Here, the demodulation unit 120 may perform channel decoding such as trellis decoding, deinterleaving, Reed-Solomon decoding, etc. In this regard, the demodulation unit 120 may include a trellis decoder, a deinterleaver, a Reed-Solomon decoder, etc.

When the digital IF (DIF) signal output from the tuner 110 is based on a DVB scheme, the demodulation unit 120 performs coded orthogonal frequency division modulation (COFDMA) demodulation. Here, the demodulation unit 120 may perform channel decoding such as convolutional decoding, deinterleaving, Reed-Solomon decoding, etc. In this regard, the demodulation unit 120 may include a convolutional decoder, a deinterleaver, and a Reed-Solomon decoder, etc.

After performing demodulation and channel decoding, the demodulation unit 120 may output a stream signal (TS). According to one embodiment, the stream signal TS may be an MPEG-2 transport stream (TS) in which a video signal of the MPEG-2 standard, an audio signal of the Dolby AC-3 standard, etc., are multiplexed. The MPEG-2 TS may include a 4-byte header and 184-byte payload.

The signal output from the demodulation unit 120 may be input to the controller 150 and undergo demultiplexing, video/audio signal processing, etc.

The signal input/output unit 130 may be connected to an external device, for example, a digital versatile disk (DVD) player, a Blu-ray player, a game player, a camcorder, a computer (e.g., a notebook computer), a set-top box, a portable device, a smartphone, etc., in a wired configuration or wirelessly to perform a signal input and output operation. In this regard, the signal input/output unit 130 may include an audio/video (A/V) input/output unit for a connection to a wired network and a wireless communication unit for a connection to a wireless network.

The A/V input/output unit may include an Ethernet terminal, a universal serial bus (USB) terminal, a composite video banking sync (CVBS) terminal, a component terminal, an S-video terminal (analog), a digital visual (DV) interface terminal, a high definition multimedia interface (HDMI) terminal, a mobile high-definition link (MHL) terminal, an RGB terminal, a D-SUB terminal, an IEEE 1394 terminal, an SPDIF terminal, a liquid HD terminal, etc. A digital signal input through such terminals may be delivered to the controller 150. An analog signal input through certain terminals (e.g., the CVBS terminal and the S-video terminal) may be converted into a digital signal through an analog-digital conversion unit and delivered to the controller 150.

The wireless communication unit may perform a wireless Internet access. For example, the wireless communication unit may perform a wireless Internet access by using a wireless LAN (WLAN), Wi-Fi, wireless broadband (Wibro), world interoperability for microwave access (Wimax), high speed downlink packet access (HSDPA), etc. Also, the wireless communication unit may perform short-range wireless communication with another device (e.g., a different electronic device). For example, the wireless communication unit may perform short-range wireless communication by using Bluetooth, radio frequency identification (RFID), infrared data association (IrDA), ultra wideband (UWB), ZigBee, etc.

The signal input/output unit 130 may access a predetermined web page via a wired/wireless network to transmit and receive data to and from a corresponding server. In addition, the signal input/output unit 130 may receive content or data, for example, content such as movies, advertisements, games, video-on-demand (VOD), broadcast signals, etc., and relevant information, provided by a content provider or a network operator. The signal input/output unit 130 may receive update information and an update file of firmware provided by a network operator or may select a desired application among applications open to the public and receive the same, via a wired/wireless network.

The signal input/output unit 130 may deliver a video signal, an audio signal, and a data signal provided from any of the earlier-noted external devices to the controller 150. Also, the signal input/output unit 130 may deliver video signals, audio signals, and data signals carrying various media files stored in an external storage device such as a memory device, a hard disk, etc., to the controller 150. Also, the signal input/output unit 130 may deliver a video signal, an audio signal, or a data signal processed by the controller 150 to the external device or any other external device.

For example, the signal input/output unit 130 may be connected to a set-top box, for example, a set-top box for an Internet protocol TV (IPTV), through at least one of the various terminals as mentioned above to perform a signal input and output operation. Also, the signal input/output unit 130 may deliver a video signal, an audio signal, and a data signal processed by the set-top box for an IPTV to the controller 150, such that bi-directional communication is available. The signal input/out unit 130 may deliver the signals processed by the controller 150 to the set-top box for an IPTV. Here, the IPTV may include an ADSL-TV, a VDSL-TV and an FTTH-TV, etc., differentiated according to a transmission network. The IPTV may include a TV over DSL, a video over DSL, a TV over IP (TVIP), a broadband TV (BTV), etc., and may further include an Internet TV, and a full-browsing TV available for Internet access.

A digital signal output from the signal input/output unit 130 also may include a stream signal (TS). As described earlier, the stream signal TS may be a signal obtained by multiplexing a video signal, an audio signal, and a data signal.

The interface unit 140 may deliver a signal input by the user to the controller 150 or may deliver a signal from the controller 150 to the user.

The interface unit 140 may deliver an input signal that is input by the user via a power key, a channel key, a volume key, a set-up key, etc., to the controller 150. Also, the interface unit 140 may include a sensor unit for sensing a user's gesture, a user's location, a user's touch, etc. In this regard, the sensor unit may include a touch sensor, a voice sensor, a location sensor, an operation sensor, a gyro sensor, etc. In such a case, the interface unit 140 may deliver an input signal from the sensor unit to the controller 150 or may transmit a signal from the controller 150 to the sensor unit.

The interface unit 140 may receive an input signal that is input by the user to control power, to select a channel, to configure a screen, etc., from the external input device 200, which may be, for example, a spatial remote controller. Also, the interface unit 140 may transmit a signal processed by the controller 160 to the external input device 200. In this case, the interface unit 140 and the external input device 200 may be connected in a wired configuration or wirelessly.

Also, the interface unit 140 may receive personal information from the external input device and/or receive information regarding an accessed Web server through such personal information. For example, when a mobile terminal is accessed within a predetermined distance from the external input device 200 to perform near-field communication, the external input device 200 may receive personal information stored in the mobile terminal, etc. Here, the personal information may be information required for accessing an electronic device or logging into a predetermined account to use a service.

The controller 150 controls a general operation of the video display device 100. In more detail, the controller 150 may demultiplex a stream signal TS received through the tuner 110, the demodulation unit 120, and/or the signal input/output unit 130 or process demultiplexed signals to generate and output a signal for outputting video and audio. For example, the controller 150 may control the tuner 110 to tune to an RF broadcast signal corresponding to a channel selected by the user or a previously stored channel.

A video signal processed by the controller 150 may be delivered to the display unit 170 to output an image (or a video) corresponding to the video signal, and the audio signal processed by the controller 150 may be delivered to the audio output unit 180 to output a sound. Also, the video signal and/or audio signal processed by the controller 150 may be input to an output device of an external device.

In order to demultiplex a stream signal TS or process demultiplexed signals to generate and output a signal for outputting video or audio, the controller 150 may include a demultiplexing unit, a video processing unit, an on-screen display (OSD) generating unit, an audio processing unit, a data processing unit, a channel browsing processing unit, etc.

The demultiplexing unit of the controller 150 demultiplexes an input stream signal TS. For example, when an MPEG-2 stream signal TS is input, the demultiplexing unit demultiplexes the input MPEG-2 stream signal TS to separate it into a video signal, an audio signal, and a data signal. As described earlier, the stream signal TS may be output from the tuner 110, the demodulation unit 120, and/or the signal input/output unit 130.

The video processing unit of the controller 150 may process the demultiplexed video signal, e.g., perform decoding on the demultiplexed video signal. In more detail, the video processing unit may decode a coded video signal of the MPEG-2 standard by using an MPEG-2 decoder, and decode a coded video signal of the H.264 standard according to a digital multimedia broadcasting scheme, a digital multimedia broadcasting (DMB) or a DVB-H scheme by using an H.264 decoder. Also, the video processing unit may process the video signal to adjust brightness, tint, color, etc., of an image. The video signal processed by the video processing unit may be delivered to the display unit 170 or may be delivered to an external output device through an external output terminal.

The OSD generating unit of the controller 150 may generate an OSD signal either according (e.g., in response) to a user input or autonomously. In more detail, for example, on the basis of at least a video signal or a data signal or an input signal received from the external input device 200, the OSD generating unit may generate a signal for displaying various types of information such as graphics or text on the screen of the display unit 170. The generated OSD signal may include various types of data such as user interface screens, various menu screens, widgets, icons of the video display device 100, a pointer corresponding to a pointing signal transmitted from the external input device 200, etc. Also, the generated OSD signal may include a two-dimensional (2D) object or a 3D object.

The controller 150 may mix the OSD signal generated by the OSD generating unit and the decoded video signal processed by the video processing unit. The mixed video signal may be changed to a frame rate of an image through a frame rate converter (FRC). Also, the mixed video signal may go through a formatter to change a format thereof so as to be output. Or, a 2D video signal and a 3D video signal may be separated or a 2D video signal may be converted into a 3D video signal, to display a 3D image.

The audio processing unit of the controller 150 may process the demultiplexed audio signal. For example, the audio processing unit may perform decoding on the demultiplexed audio signal. In more detail, the audio processing unit may decode the coded audio signal of the MPEG-2 standard by using an MPEG 2 decoder, may decode the coded audio signal of an MPEG 4 bit sliced arithmetic coding (BSAC) according to a DMB scheme by using an MPEG 4 decoder, and may decode the coded audio signal of the advanced audio codec (AAC) standard of MPEG 2 according to a satellite DMB scheme or a digital video broadcast-handheld (DVB-H) scheme. Also, the audio processing unit may process base, treble, volume control, etc. The audio signal processed by the audio processing unit may be delivered to an audio output unit 180, e.g., a speaker, or may be delivered to an external output device.

The data processing unit of the controller 150 may process the demultiplexed data signal. For example, the data processing unit may perform decoding on the demultiplexed data signal. Here, the data signal may include electronic program guide (EPG) information including broadcast information such as a start time, an end time, etc., of a broadcast program aired in each channel. In an ATSC scheme, the EPG information may include ATSC-program and system information protocol (ATSC-PSIP) information, and, in a DVB scheme, the EPG information may include DVB-service information (SI). Here, the ATSC-PSIP information or the DVB-SI information may be included in a header (4 byte) of an MPEG-2 TS.

The channel browsing processing unit of the controller 150 may receive the stream signal TS output from demodulation unit 120 or the stream signal TS output from the signal input/output unit 130, and extract an image therefrom to generate a thumbnail image. The generated thumbnail image may be input as-is to the controller 150 or may be coded and input to the controller 150. In such a case, by using the input thumbnail image, the controller 150 may display a thumbnail list including a plurality of thumbnail images on the display unit 170. Here, the thumbnail images of the thumbnail list may be displayed in the entire region of the display unit 170 or may be displayed in a partial region of the display unit 170 in a simple view manner. Also, the thumbnail images of the thumbnail list may be updated sequentially.

The controller 150 may process an analog baseband video/audio signal (CVBS/SIF). For example, the analog baseband video/audio signal (CVBS/SIF) input to the controller 150 may be an analog baseband video/audio signal output from the tuner 110 or the signal input/output unit 130. The controller 150 may process the input analog baseband video/audio signal (CVBS/SIF) and control the display unit 170 to display the processed video signal and control the audio output unit 180 to output the processed audio signal.

Also, the controller 150 may control an operation of the video display device 100 according to a user command that is input through the signal input/output unit 130 or the interface unit 140, an internal program, etc. In more detail, on the basis of device information regarding an adjacent external device located around the video display device 100, information regarding a remotely controllable channel, frequency information, code information of a different external device, etc., which is received from the signal input/output unit 130 or the interface unit 140, the controller 150 determines whether each external device, etc., has been connected according to personal information from the external input device 200. Accordingly, the controller 150 controls the display unit 170 to display an object indicating that each external device has been connected.

Also, the controller 150 may display at least one object as a 3D object on the display unit 170. Here, the object may be at least an accessed Web screen (e.g., newspaper, magazine, etc.), an electronic program guide (EPG), a menu, a widget, an icon, a still image, a video, or text.

Also, the controller 150 may sense a user gesture according to an image captured by an image capturing unit, a signal sensed by a sensing unit, or an input signal transmitted from the external input device 200, either separately or in combination.

Also, the controller 150 may recognize a user location on the basis of an image captured by the image capturing unit. For example, the controller 150 may recognize a distance (e.g., a z-axis coordinate) between the user and the video display device 100, and, additionally, the controller 150 may recognize an x-axis coordinate and a y-axis coordinate in the display unit 170 corresponding to the user location.

The storage unit 160 may store a program for signal processing and controlling of the controller 150, store a processed video signal, audio signal, and data signal, or store information regarding a predetermined broadcast channel through a channel memory function such as a channel map, etc. The storage unit 160 may include at least a flash memory, a hard disk type memory, a multimedia card micro type memory, a card type memory (e.g., an SD or XD memory), a random access memory (RAM), a static RAM (SRAM), a read-only memory (ROM), an electrically erasable programmable ROM (EEPROM), a programmable ROM (PROM), a magnetic memory, a magnetic disk, or an optical disk.

Also, the storage unit 160 may store IR format key codes for controlling different external devices, or may store IR format key databases of a plurality of external devices.

The display unit 170 converts a video signal, a data signal, or an OSD signal processed by the controller 150, or a video signal, a data signal, a control signal, etc. received from the signal input/output unit 130 or the interface unit 140 into an RGB signal, and outputs an image on the basis of the RGB signal. The display unit 170 may be implemented in various forms such as a plasma display panel (PDP), a liquid crystal display (LCD), a thin film transistor-LCD (TFT-LCD), an organic light emitting diode (OLED) display, a flexible display, a three-dimensional (3D) display, an e-ink display, etc.

For example, when the display unit 170 is a 3D display, the display unit 170 may be implemented according to an additional display scheme or a single display scheme for 3D viewing. According to the single display scheme, the display unit 170 alone may implement a 3D image without requiring an additional display scheme, for example, glasses. The single display scheme may include a lenticular scheme, a parallax barrier scheme, etc. Also, according to the additional display scheme, the display unit 170 may implement a 3D image by using a 3D viewing device. For example, the additional display scheme may include a head mount display (HND) scheme, a glasses scheme, etc.

Also, in an embodiment in which the display unit 170 is implemented as a touch screen equipped with a touch sensor, the display unit 170 may serve as an input device as well as as an output device.

The touch sensor may be configured to convert pressure applied to a particular portion of the display unit 170 or a change in the capacitance (or similar characteristic) generated at a particular portion of the display unit 151 to an electrical input signal. The touch sensor may be configured to detect the pressure when a touch is applied, as well as the touched position and area of a touch object. Here, the touch object may include a finger, a touch pen, a stylus pen, a pointer, etc. When there is a touch input with respect to the touch sensor, a corresponding signal (or signals) is transmitted to a touch controller. The touch controller processes the signals and transmits corresponding data to the controller 150. Accordingly, the controller 150 may recognize which portion of the display unit 151 has been touched.

The audio output unit 180 may receive an audio signal, for example, a stereo signal or a 5.1-channel signal, processed by the controller 150, and output (or reproduce) a corresponding sound. The audio output unit 180 may be implemented as any of various types of speakers.

The video display device 100 may also include an image capturing unit for capturing an image of the user. The image capturing unit may be implemented as a single camera, but embodiments of the present invention are not limited thereto. For example, the image capturing unit may be implemented as a plurality of cameras. Image information captured by the image capturing unit may be input to the controller 150, and, thus, the controller 150 may sense a user's gesture on the basis of the captured image.

Also, the video display device 100 may include a video communication unit including a microphone in addition to the image capturing unit. The controller 150 may process image information captured by the image capturing unit and audio information collected by the microphone and transmit the same to a video communication device of a counterpart device through the signal input/output unit 130 or the interface unit 140.

A power supply unit supplies power to the video display device 100. In particular, the power supply unit may supply power to the controller 150 that may be implemented in the form of a system on chip (SOC), the display unit 170 for displaying an image, and the audio output unit 180 for outputting a sound.

In this regard, the power supply unit may include a converter for converting alternating current (AC) power into direct current (DC) power. In an embodiment in which the display unit 170 is implemented as a liquid crystal panel having a plurality of backlight lamps, the power supply unit may further include an inverter that may be able to perform a pulse width modulation (PWM) operation for the purpose of varying luminance or dimming driving.

The external input device 200 may be connected to the interface unit 140 in a wired manner or wirelessly, and may transmit an input signal generated according to a user input to the interface unit 140. The external input device 200 may include a remote controller (for example, a spatial remote controller), a mouse, a keyboard, a wheel, etc. The remote controller may transmit an input signal to the interface unit 140 through Bluetooth, RF communication, infrared communication (IR communication), ultra-wideband (UWB), ZigBee, etc. In particular, when the external input device 200 is implemented as a spatial remote controller, it may sense an operation of a body of the spatial remote controller and generate an input signal.

The video display device 100 may be implemented as a fixed digital broadcast receiver or a mobile digital broadcast receiver.

In an embodiment in which the video display device 100 is implemented as a fixed digital broadcast receiver, the video display device may be implemented to receive at least a digital broadcast based on an ATSC scheme (8-VSB scheme) using a single carrier, a digital broadcast based on a terrestrial DVB-T scheme (COFDM scheme) using a plurality of carriers, a digital broadcast based on an ISBD-T (BST-OFDM scheme) allowing for using different broadcast channels according to user authority, etc.

In an embodiment in which the video display device 100 is implemented as a mobile digital broadcast receiver, the video display device may be implemented to receive at least a digital broadcast based on a terrestrial DMB scheme, a digital broadcast based on a satellite DMB scheme, a digital broadcast based on an ATSC-M/H scheme, a digital broadcast based on a digital video broadcast-handheld (DVB-H), a digital broadcast based on a media forward link only (MediaFLO), etc.

The video display device 100 may be implemented as a digital broadcast receiver for cable, satellite communication, and an IPTV.

Also, features of the video display device 100, as described with reference to various embodiments, may also be applied to a mobile terminal. The mobile terminal may include a mobile phone, a smart phone, a notebook computer, a digital broadcast receiver, a personal digital assistant (PDA), a portable multimedia player (PMP), a navigation device, a slate PC, a tablet PC, an ultra-book, etc.

In an embodiment in which the video display device is used as a mobile terminal, a wireless communication unit may be further provided in addition to components described earlier. The wireless communication unit allows wireless communication between the mobile terminal and a wireless communication system or between the mobile terminal and a network in which the mobile terminal is located.

In this regard, the wireless communication unit may include at least a broadcast receiving module, a mobile communication module, a wireless Internet module, a short-range communication module, or a location information module.

The broadcast receiving module may receive broadcast signals and/or broadcast associated information from a broadcast management server via a broadcast channel.

Here, the broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, etc. Also, the broadcast signal may further include a broadcast signal combined with a TV or radio broadcast signal.

Here, the broadcast associated information may refer to information associated with a broadcast channel, a broadcast program or a broadcast service provider. The broadcast associated information may also be provided via a mobile communication network. Also, the broadcast associated information may exist in various forms. For example, it may exist in the form of an electronic program guide (EPG) of digital multimedia broadcasting (DMB), an electronic service guide (ESG) of digital video broadcast-handheld (DVB-H), etc.

The broadcast receiving module 111 may be configured to receive digital broadcast signals by using a digital broadcast system such as multimedia broadcasting-terrestrial (DMB-T), digital multimedia broadcasting-satellite (DMB-S), media forward link only (MediaFLO®), digital video broadcast-handheld (DVB-H), DVB-convergence of broadcasting and mobile service (CBMS), open mobile alliance-broadcast (OMA-BCAST), China multimedia mobile broadcasting (CMMB), mobile broadcasting business management system (MBBMS), integrated services digital broadcast-terrestrial (ISDB-T), etc. The broadcast receiving module may be configured to be suitable for any other broadcast system that provides a broadcast signal, as well as the above-mentioned digital broadcast systems.

Broadcast signals and/or broadcast-associated information received via the broadcast receiving module may be stored in a memory.

The mobile communication module transmits and/or receives radio signals to and/or from at least a base station, an external terminal, or a server in a mobile communication network. Such radio signals may include an audio call signal, a video call signal or various types of data according to text and/or multimedia message transmission and/or reception.

The mobile communication module implements a video call mode and an audio call mode. The video call mode refers to a state in which a user performs call communication while viewing an image of a counterpart, and the audio call mode refers to a state in which the user performs call communication without viewing an image of a counterpart. In order to implement the video call mode and an audio call mode, the mobile communication module is formed to transmit and receive at least a sound or an image.

The wireless Internet module supports wireless Internet access for the mobile terminal. This module may be internally or externally coupled to the terminal. The wireless Internet access technique implemented may include a WLAN (Wireless LAN), (Wi-Fi) direct, digital living network alliance (DLNA), Wibro (Wireless broadband), Wimax (World Interoperability for Microwave Access), HSDPA (High Speed Downlink Packet Access), GSM, CDMA, WCDMA, LTE (Long Term Evolution), etc.

The short-range communication module is a module for supporting short range communications. As the short-range communication technology, Bluetooth™, Radio Frequency IDentification (RFID), Infrared Data Association (IrDA), Ultra-WideBand (UWB), ZigBee™, Wi-Fi direct, etc., may be used.

The location information module is a module for checking or acquiring a location of the mobile terminal. A typical example of the location information module is a GPS (Global Positioning System) or a WiFi (Wireless Fidelity) module.

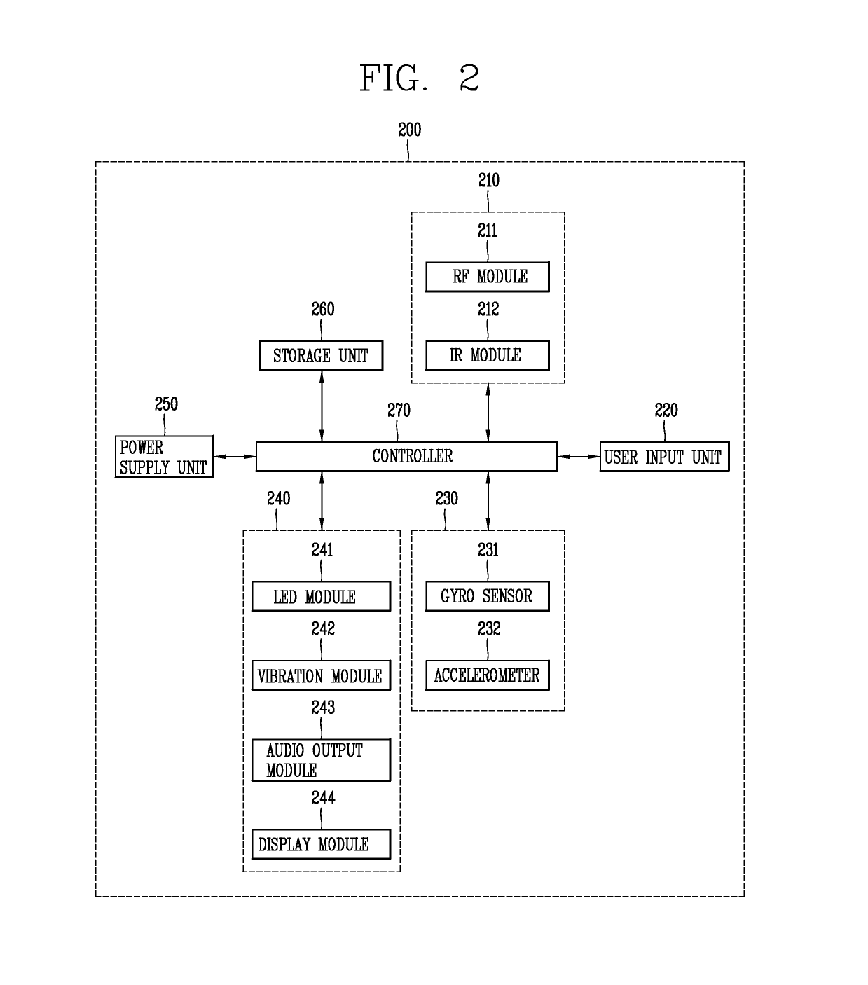

FIG. 2 is a block diagram of an external input device 200 according to one embodiment. The external input device 200 may include a wireless communication unit 210, a user input unit 220, a sensing unit 230, an output unit 240, a power supply unit 250, a storage unit 260, and a controller 270.

With reference to FIG. 2, the wireless communication unit 210 may transmit a signal to the video display device 100 or may receive a signal from the video display device 100. In this regard, the wireless communication unit 210 may include an RF module 211 and an IR module 212. The RF module 211 is connected to the interface unit 140 of the video display device 100 according to an RF communication standard to transmit and receive a signal, and the IR module 212 is connected to the interface unit 140 of the video display device 100 according to an IR communication standard to transmit and receive a signal. For example, the wireless communication unit 210 may transmit a signal including information regarding a movement of the external input device 200, etc., to the video display device 100 through the RF module 211.

The external input device 200 may further include an NFC module for near-field communication with an external device. Through near field communication with a predetermined external device, the external input device 200 may receive personal information, information regarding a Web server connected through the personal information, etc., and transmit the received information to the video display device 100 through the RF module 211 or the IR module 212.

Additionally, the external input device 200 may transmit a signal to the interface unit 140 of the video display device 100 by using Bluetooth, IR communication, UWB, ZigBee, NFC, etc.

The external input device 200 may receive a video, audio, or data signal, etc., output from the interface unit 140 of the video display device 100. On the basis of the received video, audio, or data signal, the external input device 200 may display an image or output a sound.

Also, the external input device 200 may receive device information of a different external device, remotely controllable channel information, frequency information, or code information of a different external device, etc., from an adjacent external device therearound, and may allocate a channel, frequency, or code to the corresponding external device on the different external device information to perform remote controlling.

The user input unit 220 may include a keypad, a key button, a touch screen, a scroll key, a jog key, etc., to facilitate entering of an input. The user may input a control command in relation to the video display device 100 by manipulating the user input unit 220. Such a control command may be input by the user through a push operation of a hard key button of the user input unit 200. Also, in an embodiment in which the user input unit 220 includes a touch screen, such a command may be input by touching a soft key of the touch screen by the user.

The user input unit 220 may include, for example, an OK key, a menu key, a four-direction key, a channel control key, a volume control key, a back key, a home key, etc. The OK key may be used to select a menu or an item, and the menu key may be used to display a predetermined menu. Also, the four-direction key may be used to move a pointer or an indicator displayed on the display unit 170 of the video display device 100 up/down or left/right. Also, the channel control key may be used to control a channel up and down, and the volume control key may be used to control volume up and down. Also, the back key may be used to move a current screen to a previous screen, and the home key may be used to move a current screen to a home screen.

The OK key may be implemented by adding a scroll function (or capability). In this regard, the OK key may be implemented in the form of a wheel key. Namely, when the user pushes the OK key up/down or left/right, a corresponding menu or item may be selected, and when the user rotates the provided wheel up and down, a screen output to the display unit 170 of the video display device 100 may be scrolled or changed to a next list page according to a direction corresponding to the rotation of the wheel. For example, in a situation in which only a portion of the entire screen to be output to the display unit 170 is displayed, the user may scroll the wheel of the OK key to search (or locate) a desired portion of the screen, and a screen region which had not been output to the display unit 170 may be output to the display unit 170. In another example, in a situation in which a list page is displayed on the display unit 170, the user may scroll the wheel of the OK key to display a previous page or a next page of a current page displayed on the display unit 170.

Also, the scroll function of the OK key may be implemented as a separate key.

The sensing unit 230 may include a gyro sensor 231 and an accelerometer 232. The gyro sensor 231 may sense a spatial movement of the external input device 200 on the basis of an x axis, a y axis, and a z axis. The accelerometer 232 may sense a movement speed, etc., of the external input device 200.

Also, the sensing unit 230 may further include a distance measurement sensor, and a distance to the display unit 170 may be sensed by using the distance measurement sensor.

The output unit 240 may output information corresponding to manipulation of the user input unit 220 and information corresponding to a transmission signal of the video display device 100. Thus, the user may recognize a manipulation state of the user input unit 220 or a control state of the video display device 100 through the output unit 240. The output unit 240 may include an LED module 241, a vibration module 242, an audio output module 243, and a display module 244. In response to a manipulation of the user input unit 220 or a signal transmitted and received through the wireless communication unit 210, the LED module 241 may be turned on, the vibration module 242 may generate vibrations, and the display module 244 may output an image.

The power supply unit 250 may supply power to various components (including electronic elements) of the external input device 200. When the external input device 200 does not move (or is not operated) for a predetermined period of time, the power supply unit 250 may stop power supply to reduce power consumption. When a predetermined key of the external input device 200 is manipulated, the power supply unit 250 may resume power supply.

The storage unit 260 may store various programs, applications, frequency band information, etc., in relation to controlling or operation of the external input device 200. Also, the storage unit 260 may store IR format key codes for controlling different external devices by an IR signal, and may store IR format key databases of a plurality of external devices.

The controller 270 may perform a general controlling operation of the external input device 200. The controller 270 may transmit a signal corresponding to a predetermined key manipulation of the user input unit 220 to the video display device 100 through the wireless communication unit 210. Also, the controller 270 may transmit a signal corresponding to a movement of the external input device 200 sensed by the sensing unit 230 to the video display device 100 through the wireless communication unit 210, and the video display device 100 may calculate coordinate values of a pointer corresponding to the movement of the external input device 200.

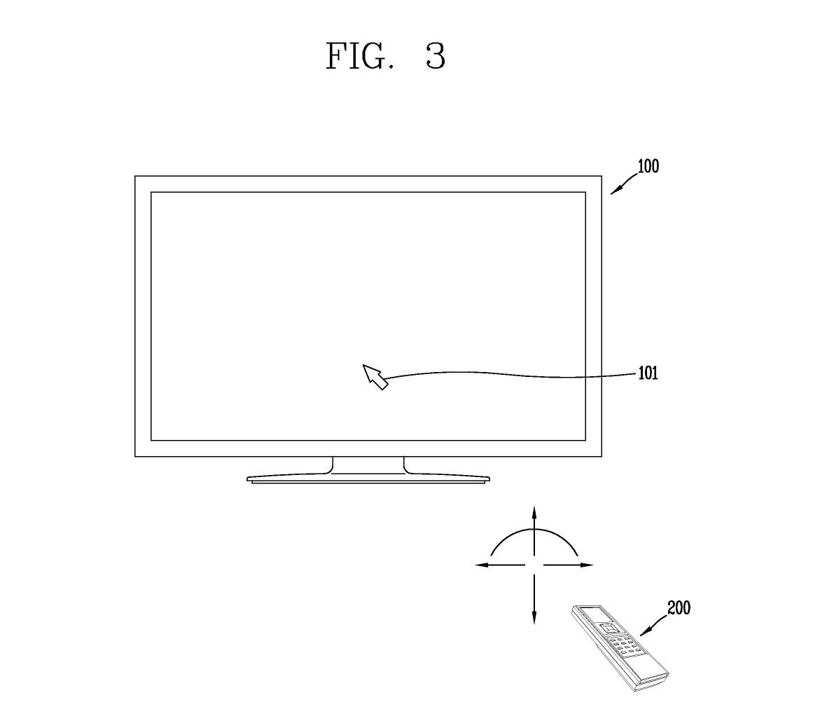

FIG. 3 illustrates an interaction between a video display device 100 and an external input device 200 according to one embodiment. By way of example, the video display device 100 is illustrated as a TV receiver, and the external input device 200 is illustrated as a spatial remote controller.

With reference to FIG. 3, the external input device 200 may transmit or receive a signal to or from the video display device 100 according to an RF communication standard. A control menu may be displayed on a screen of the video display device 100 according to a control signal from the external input device 200. In this regard, the external input device 200 may include a plurality of buttons, and may generate an external input signal according to a user's manipulation (or operation) of the buttons. Also, the external input device 200 may transmit information regarding a movement in a 3D space of the external input device 200 to the video display device 100. The information may be sensed by the sensing unit (e.g., sensing unit 230).

With reference to FIG. 3, when the user moves or rotates the external input device 200 up/down, left/right, forward/backward, a pointer 101 corresponding to the movement of the external input device 200 may be displayed on the screen of the video display device 100. According to one embodiment, the pointer 101 has the shape of an arrow. Since the displayed corresponding pointer 101 moves on the screen of the video display device 100 according to the movement of the external input device 200 in the 3D space, the external input device 200 may be called a spatial remote controller.

The information regarding the movement of the external input device 200 sensed by the sensing unit of the external input device 200 is transmitted to the video display device 100. Then, the video display device 100 may calculate X and Y coordinates of the corresponding pointer from the information regarding the movement of the external input device 200. The video display device 100 may display the pointer 101 corresponding to the calculated coordinates.

During a state in which a particular button provided in the external input device 200 is pressed, when the user moves the external input device 200 to be away (or further) from the screen of the video display device 100, a selected region of the screen corresponding to the displayed pointer 101 may be zoomed in (or zoomed out) so as to be magnified (or reduced). Conversely, when the user moves the external input device 200 to be closer to the screen of the video display device 100, a selected region of the screen corresponding to the displayed pointer 101 may be zoomed out (or zoomed in) so as to be reduced (or magnified).

During a state in which a particular button provided in the external input device 200 is pressed, recognition of a vertical (up/down) or horizontal (left/right) movement of the external input device 200 may be paralyzed (or disabled). Namely, in this situation, when the external input device 200 is moved to be further away from or closer to the screen of the video display device 100, an up/down/left/right movement may not be recognized, and only a forward/backward movement may be recognized.

Also, a movement speed and a movement direction of the displayed pointer 101 and a speed of scrolling the screen according to a movement of the pointer 101 may be determined according to a movement speed and/or a movement direction of the external input device 200.

As described earlier, the pointer 101 may have the shape of an arrow (see FIG. 3). Alternatively, the pointer 101 may have any of various other shapes. For example, the pointer 101 may have a shape of a dot, a cursor, a prompt, an outline, etc.

According to a particular embodiment, at least one object whose function is activated by a pointing signal may be displayed in a region of the display unit 170 of the video display device 100. The controller 150 may receive the pointing signal from the external input device 200 (e.g., the spatial remote controller of FIG. 3) via the interface unit 140. When the pointer displayed on the display unit 170 moves within a first region (in which an object is not displayed) according to the received pointing signal, the controller 150 controls the pointer to move at a first movement speed. Also, when the pointer displayed on the display unit 170 moves within a second region (in which an object is displayed) according to the received pointing signal, the controller 150 controls the pointer to move at a second movement speed slower than the first movement speed.

Accordingly, when an object (e.g., a key) displayed in the video display device 100 is selected by using the pointing signal transmitted from the external input device 200, if the pointer enters a region in which the object is present, a movement speed of the pointer is reduced such that the pointer is less easily (or less readily) moved out of the region in which the object is present. This provides an environment in which a user-desired controlling (for example, object selection) can be more accurately performed.

Hereinafter, a content control apparatus capable of effectively managing and executing content and a method of operating the content control apparatus will be described in more detail.

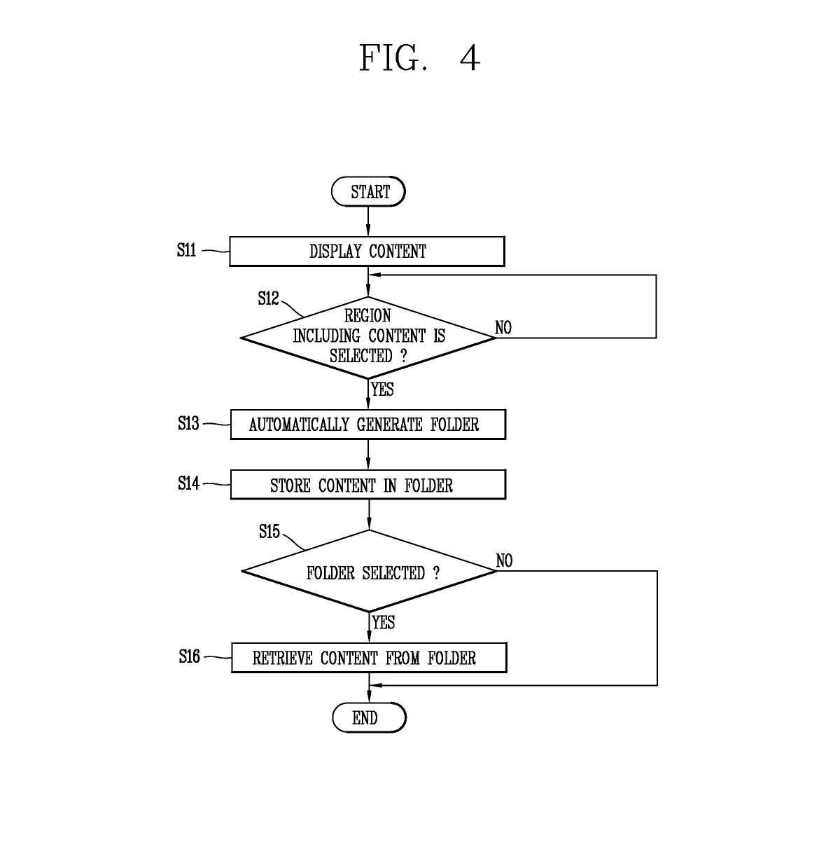

FIG. 4 is a flow chart illustrating a method of operating a content control apparatus according to one embodiment.

With reference to FIG. 4, the display unit 170 displays content items according to a user request (S11). The content items may include icons, photo files, video files, music files, document files, etc., linked to various application programs (for example, an Internet application program, a broadcast associated application program, a video reproduction application program, a music reproduction application program, a photograph application program, etc.).

The controller 150 may determine whether a region including content items displayed on the display unit 170 is selected (S12). For example, the controller 150 determines whether particular content is selected by the user from among the content items displayed on the display unit 170.

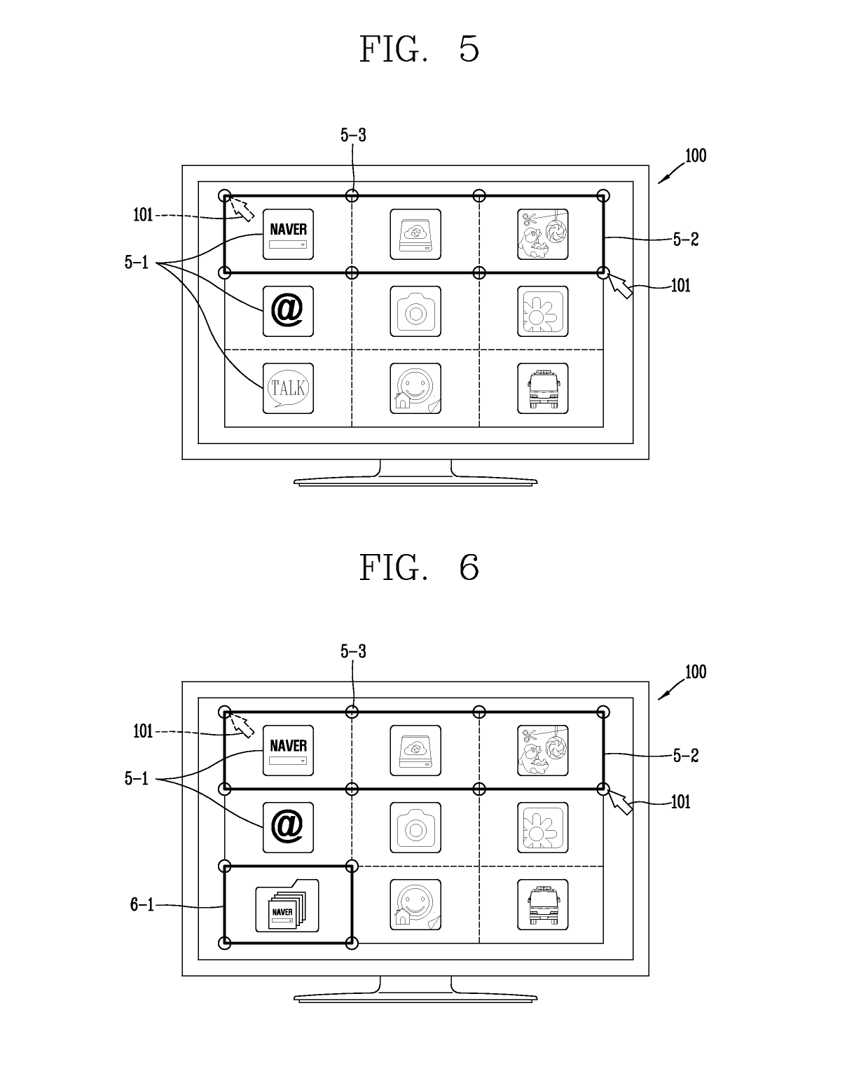

FIG. 5 illustrates an example of selection of content items.

With reference to FIG. 5, when the pointer 101 corresponding to a movement of the external input device 200 is positioned in the display unit 170, the controller 150 generates a grid indicating regions of the display unit 170 (or the grid may divide the display unit 170 into regions). The controller 150 displays the generated grid on the display unit 170. With reference to FIG. 5, a single content item 5-1 is displayed in each region of the displayed grid. According to one embodiment, the controller 150 may generate the grid and display the generated grid on the display unit 170 when an editing event occurs.

When the pointer 101 is positioned on a guide line of the displayed grid, the controller 150 may display a notification window (or a notification drawing) on the display unit 170. For example, when the pointer 101 is positioned on a guide line of the displayed grid, the controller 150 may display a notification window (e.g., a usage manual, etc.) providing descriptions regarding how to set a content region, how to generate a folder, how to delete a folder, etc., on the display unit 170. The notification window may be a pop-up window, a text balloon, a description box, etc.

The controller 150 determines whether a first region 5-2 for selecting particular content items from among content items 5-1 displayed on the display unit 170 is selected. The first region 5-2 may be selected via the pointer 101 corresponding to a movement of the external input device 200. For example, FIG. 5 illustrates a state in which a button (for example, a left button function of a mouse) installed in the external input device 200 for setting a region is selected, three regions of the displayed grid are selected via the pointer 101 of the external input device 200, and the selected button is subsequently released (e.g., a drag & release operation). The controller 150 determines that the first region 5-2 for selecting particular content items within the three selected regions is selected. The content items may be selected according to various ways via a user touch input or the pointer 101, a mouse, etc., corresponding to the movement of the external input device 200. The controller 150 may perform an operation to select the particular content items in a content editing mode.

When a picker (e.g., sizing handle) 5-3 positioned on the outline of the region 5-2 for selecting the particular content items is moved by the pointer 101, the controller 150 may decrease or increase a size of the region 5-2.

FIG. 6 illustrates another example of selection of content items.

With reference to FIG. 6, the controller 150 may determine whether a plurality of regions 5-2 and 6-1 for selecting particular content items from among the content items 5-1 displayed on the display unit 170 are selected. The regions 5-2, 6-1 may be selected via the pointer 101 corresponding to a movement of the external input device 200. For example, the controller 150 may determine whether a first region (for example, region 5-2 of FIG. 6) and a second region (for example, region 6-1 of FIG. 5) are selected via the pointer 101 corresponding to a movement of the external input device 200. With reference to FIG. 6, the first region 5-2 is for selecting a plurality of content items displayed on the display unit 170, and the second region 6-1 is for selecting a single content item displayed on the display unit 170

The content items included in the plurality of regions 5-2 and 6-1 may include a folder including a plurality of content items, icons, photo files, video files, music files, document files, etc. For example, a content item may represent a folder that stores a plurality of content items, icons, photo files, video files, music files, document files, etc.

With reference to FIG. 5, when it is determined that the region 5-2 for selecting particular content items from among the content items 5-1 displayed on the display unit 170 is selected, the controller 150 automatically generates a folder (FIG. 4, S13). In more detail, when it is determined that the region 5-2 for selecting particular content items from among the contents 5-1 displayed on the display unit 170 is selected, the controller 150 automatically generates a folder and displays the generated folder in (or at) a display position of any one of the selected particular content items.

With reference to FIG. 6, when it is determined that the regions 5-2 and 6-1 for selecting particular content items from among the content items 5-1 displayed on the display unit 170 are selected, the controller 150 automatically generates a folder (FIG. 4, S13) and displays the generated folder in (or at) a display position of any one of the selected particular content items. According to one embodiment, when one of the content items included in the regions 5-2 and 6-1 is a folder, the controller 150 may delete the folder and store (or display) the content item (or content items) of the deleted folder and remaining content items included in the regions 5-2 and 6-1 in a generated folder.

With reference back to FIG. 4, the controller 150 may automatically store (or display) the selected particular content items in the generated folder (S14).

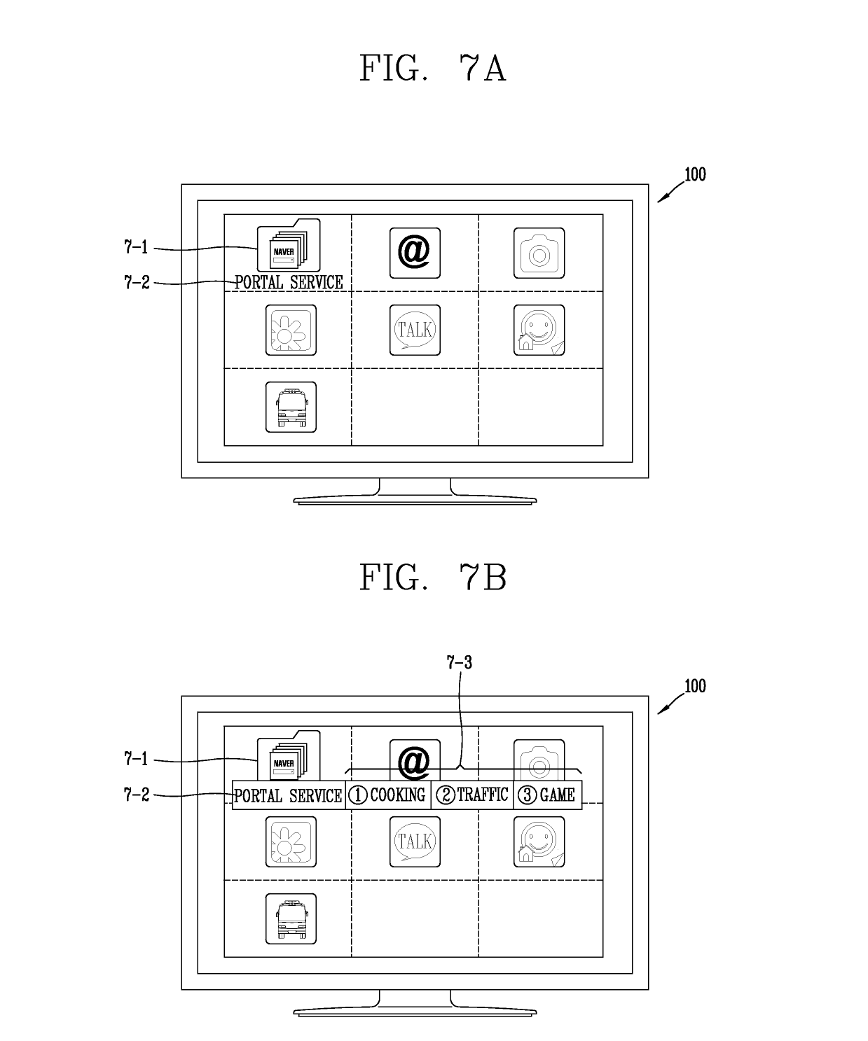

FIG. 7A illustrates an example of a generated folder according to one embodiment.

With reference to FIG. 7A, the controller 150 stores (and/or displays) the selected particular content items in a generated folder 7-1. For example, with additional reference back to FIG. 5, the three selected content items (i.e., the three content items 5-1 that are displayed in the region 5-2) are stored (and/or displayed) in the generated folder 7-1.

The controller 150 detects (or determines) a category (e.g., characteristic or property) that is common to the selected particular content items. For example, the common category may be a portal service, a social media, a video, a photo, music, etc. The controller may automatically set a name corresponding to the common category as a name 7-2 of the generated folder 7-1. For example, when a common category of the selected particular content items is ‘portal service or social media’, the controller 150 may set a name 7-2 of the generated folder 7-1 to ‘portal service or social media’.

According to one embodiment, the controller 150 detects categories of each of the selected particular content items. The controller 150 selects a category having a highest proportion (e.g., highest occurrence of detection) from among various detected categories (e.g., portal service, social media, video, photo, music, etc.) with respect to the selected particular content items, and automatically sets a name of the generated folder as the name corresponding to the selected category.

According to one embodiment, the set name of the folder may be edited.

FIG. 7B illustrates another example of a generated folder according to one embodiment.

With reference to FIG. 7B, the controller 150 detects (or determines) categories (e.g., characteristics or properties) of the selected particular content items. The detected categories may include portal service, social media, video, photo, music, etc. The controller 150 may select a category having the highest proportion (e.g., highest occurrence of detection) from among the detected categories of the selected content items, and automatically set a name corresponding to the selected category as a name 7-2 of the generated folder 7-1.

Also, the controller 150 may arrange the categories (e.g., portal service, social media, video, photo, music, etc.) of the selected content items in order, starting from the category having the highest proportion (e.g., highest occurrence of detection). Alternatively, the controller 150 may arrange the categories in order, starting from the category which has been most frequently used (according to priority), set names respectively corresponding to the arranged categories as folder names, and display a folder name list 7-3 including the set folder names together with the automatically set folder name 7-2. When a particular folder name among the folder names (categories) included in the folder name list 7-3 is selected by the user, the controller 150 may change the automatically set folder name 7-2 to the selected folder name.

In a situation in which all the content items of the folder 7-1 belong to the same category, the folder name list 7-3 may not be displayed.

When detected categories of particular content items of the folder 7-1 are of the same (or equal) proportion (e.g., the detected categories have an equal detection occurrence), the controller 150 may automatically set a category of a content item having the highest frequency (i.e., the content item which has been most frequently used) among the particular content items as the name 7-2 of the generated folder.

When the categories of the content items of the folder 7-1 are different and the categories are of an equal proportion, the controller 150 may automatically set a category of the most frequently used content item, as a name 7-2 of the generated folder. The controller 150 may arrange the different content items of the folder 7-1 in order of frequency of usage, set each category of the arranged content items as a folder name, and display a folder name list (a candidate folder name list) 7-3 including the respective set folder names (respective folder candidate names) together with the automatically set folder name 7-2.

When it is determined that a region for selecting (or merging) a particular content item and a particular folder is selected, the controller 150 may automatically generate a new folder, store the selected (merged) content item and the particular folder in the generated new folder, and automatically set a category having the highest frequency of usage or a category having the highest proportion, among the categories of the stored content item and the content items of the particular folder, as a name of the generated new folder. When a name of the particular folder has been edited by the user, the controller 150 may automatically set the edited name of the particular folder as the name of the generated new folder, rather than automatically setting the category having the highest frequency of usage or the category having the highest proportion as the name of the generated new folder.

When it is determined that a region for selecting (or merging) a first folder and a second folder is selected, the controller 150 may automatically generate a new folder, store the selected (or merged) first and second folders in the generated new folder, and automatically set the category having the highest frequency of usage or the category having the highest proportion, among the categories of the content items of the stored first and second folders, as the name of the generated new folder. When a name of the first folder has been edited by the user, the controller 150 may automatically set the edited name of the first folder, as a name of the generated new folder, rather than automatically setting the category having the highest frequency of usage or the category having the highest proportion as the name of the generated new folder.

The controller 150 may display representative images in the generated folder 7-1 such that portions of the representative images overlap with each other. Each of the representative images may denote a respective content item of the generated folder 7-1. According to a further embodiment, the controller 150 may display the representative images denoting content items of the generated folder 7-1 in the generated folder, starting with a content item which has been most recently used or starting from a content item which has been most frequently used, among the content items of the generated folder 7-1.

With reference back to FIG. 4, the controller 150 determines whether the generated folder 7-1 is selected (S15). For example, the controller 150 determines whether the generated folder 7-1 has been touched or an event for retrieving the content items from the generated folder has occurred (or has been detected). The event may be an event such as manipulation of a button (a particular button of the external input device 200) for retrieving the content items from the generated folder 7-1, a gesture of shaking the generated folder, a gesture of drawing a circle while the generated folder is touched, etc.

With continued reference to FIG. 4, when the generated folder is selected, the controller 150 may automatically retrieve all the content items of the generated folder at a time (S16). For example, when the generated folder 7-1 is touched or an event for retrieving the content items from the generated folder occurs (or is detected), the controller 150 may automatically retrieve all the content items from the generated folder and arrange and display the retrieved content items on the display unit 170. The controller 150 may delete the generated folder 7-1 as soon as it retrieves the content items from the generated folder. For example, the controller 150 may delete the generated folder 7-1 concurrently with retrieving the content items from the generated folder and arranging and displaying the retrieved content items.

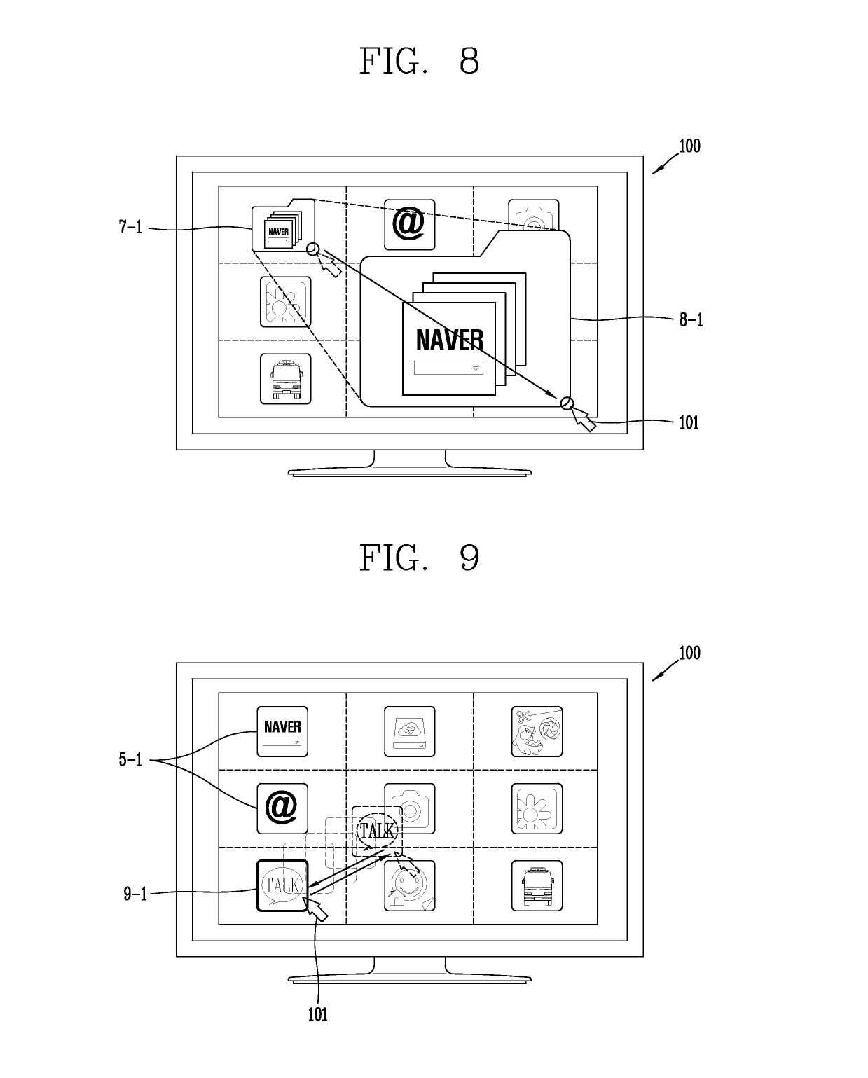

FIG. 8 illustrates deletion of a generated folder according to one embodiment.

With reference to FIG. 8, when a particular region (for example, an end or a corner of the outline) of the generated folder 7-1 is selected, dragged, and subsequently released, the controller 150 may delete the generated folder 7-1 and simultaneously (or concurrently) arrange and display the content items of the generated folder 7-1 on the display unit 170.

When a pointer 101 of the external input device 200 is positioned at or near the generated folder 7-1, the controller 150 may display an icon (for example, a circular icon, a star-like icon, etc.) for selecting the particular region (e.g., the end or the corner of the outline of the folder) in the particular region of the generated folder.

When the particular region (for example, the end or the corner of the outline) of the generated folder 7-1 is selected and dragged, the controller 150 may display a folder 8-1 corresponding to the generated folder 7-1. The size of the folder 8-1 may be larger or smaller than the size of the generated folder 7-1 according to a drag position. With reference to FIG. 8, the size of the folder 8-1 is larger than the size of the generated folder 7-1.

When the folder 7-1 is selected, the controller 150 may magnify (or enlarge) both the folder 7-1 and representative images of the content items of the folder, and, when a particular representative image is selected from among the representative images, the controller 150 may execute a content item corresponding to the selected particular representative image.

According to embodiments of the present invention, when one of the plurality of content items is selected, the controller 150 may automatically generate a folder and store (or display) the selected single content item in the generated folder.

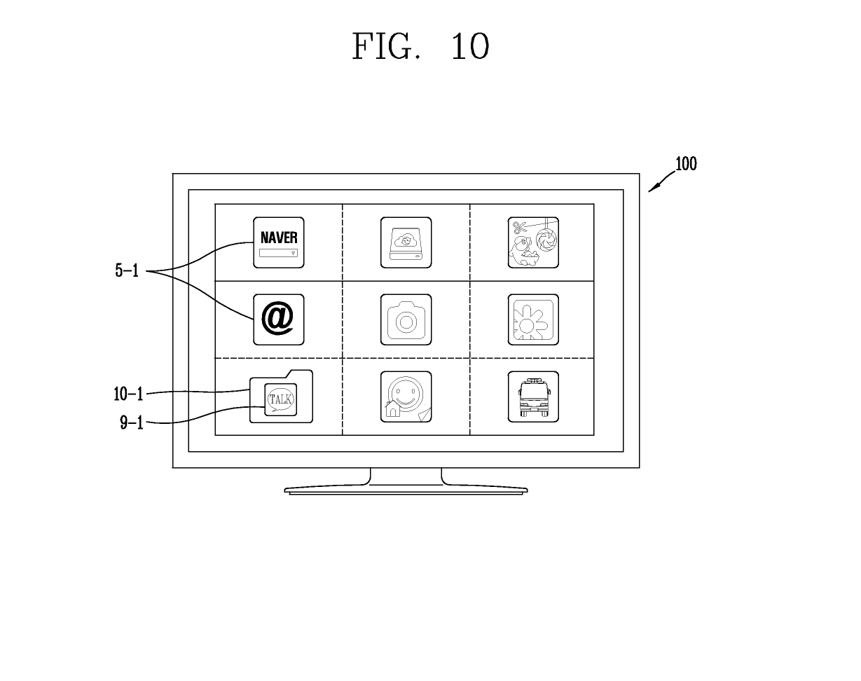

FIGS. 9 and 10 illustrate generation of a folder when a single content item is selected according to one embodiment.

With reference to FIG. 9, in a situation in which a single content item 9-1 is selected from among a plurality of content items 5-1, the controller 150 may determine whether a pre-set event for generating a folder has occurred. For example, in a situation in which the single content item 9-1 is selected, the controller 150 determines whether a gesture of shaking the single content item 9-1 or a gesture of drawing a circle to (or around) the single content 9-1 has occurred.

With reference to FIG. 10, when the single content item 9-1 is selected and the pre-set event for generating a folder occurs, the controller 150 generates a folder 10-1 at a display position of the selected content item 9-1 and stores (or displays) the selected content item 9-1 in the generated folder 10-1. For example, in a situation in which the single content item 9-1 is selected, when an event such as a gesture of shaking the single content 9-1 or a gesture of drawing a circle to (or around) the single content 9-1 occurs, the controller 150 generates the folder 10-1 at the display position of the selected content item 9-1 and stores (or displays) the selected content item 9-1 in the generated folder 10-1.

Thus, according to the content control apparatus and the method of operating the content control apparatus of embodiments of the present invention, when content items are selected by the user, a folder may be automatically generated, and the selected content items may be automatically stored (or displayed) in the generated folder, such that content items that are desired by a user can be easily and quickly stored (or displayed) in the folder.

According to the content control apparatus and the method of operating the content control apparatus of embodiments of the present invention, whenever a pre-set event for retrieving content items from the generated folder occurs, the content items of the folder are automatically retrieved and displayed, such that the user may quickly and easily retrieve the content items of the folder. For example, if it is assumed that five content items are stored in a single folder, a process of sequentially retrieving the five content items of the folder one by one may be avoided, and the user can quickly and easily retrieve the content items from the folder.

A content control apparatus for effectively displaying and executing content items of a folder and a method of operating the content control apparatus according to embodiments of the present invention will now be described in more detail.

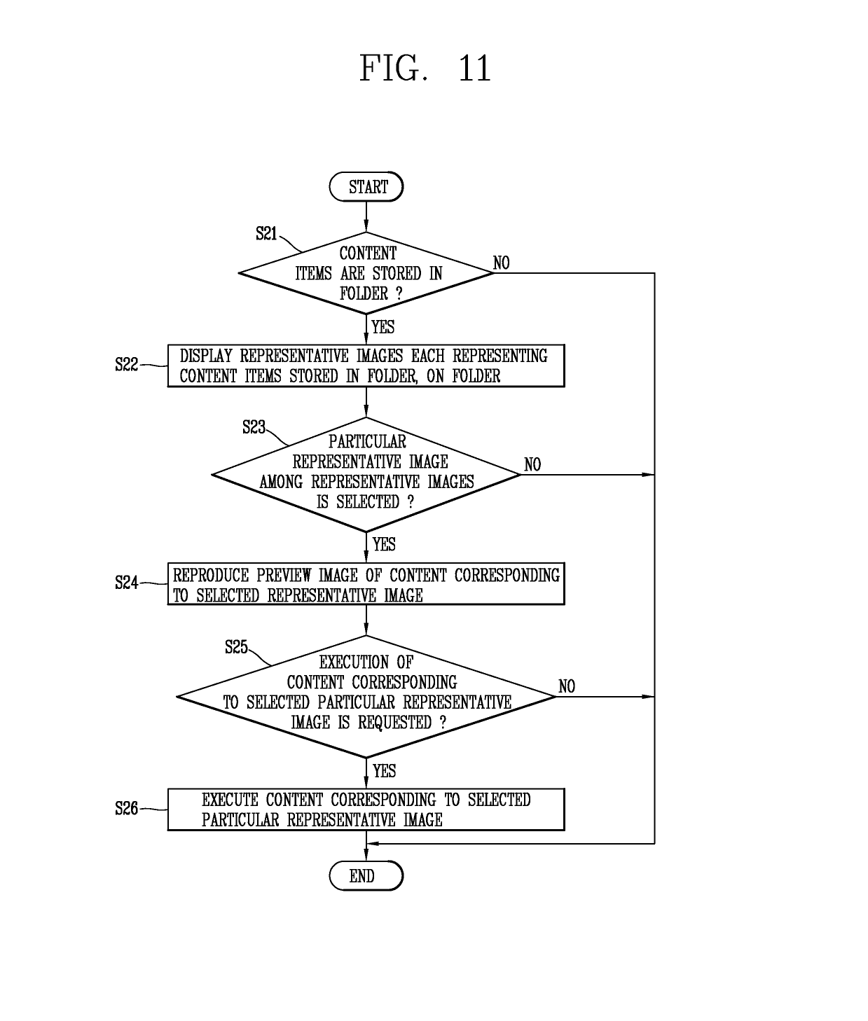

FIG. 11 is a flow chart illustrating a content control method according to one embodiment.

With reference to FIG. 11, the controller 150 determines whether content items selected by the user have been automatically stored in a folder (S21). Because the automatic storing (and/or displaying) of selected content items in a folder has been described earlier with reference to other embodiments (e.g., embodiments described earlier with reference to FIGS. 4 through 10), the automatic storing (and/or displaying) of selected content items will not be described in further detail below.

When the content items selected by the user are automatically stored in a folder, the controller 150 displays representative images (e.g., thumbnail images) respectively representing the content items stored in the folder on the folder (S22).

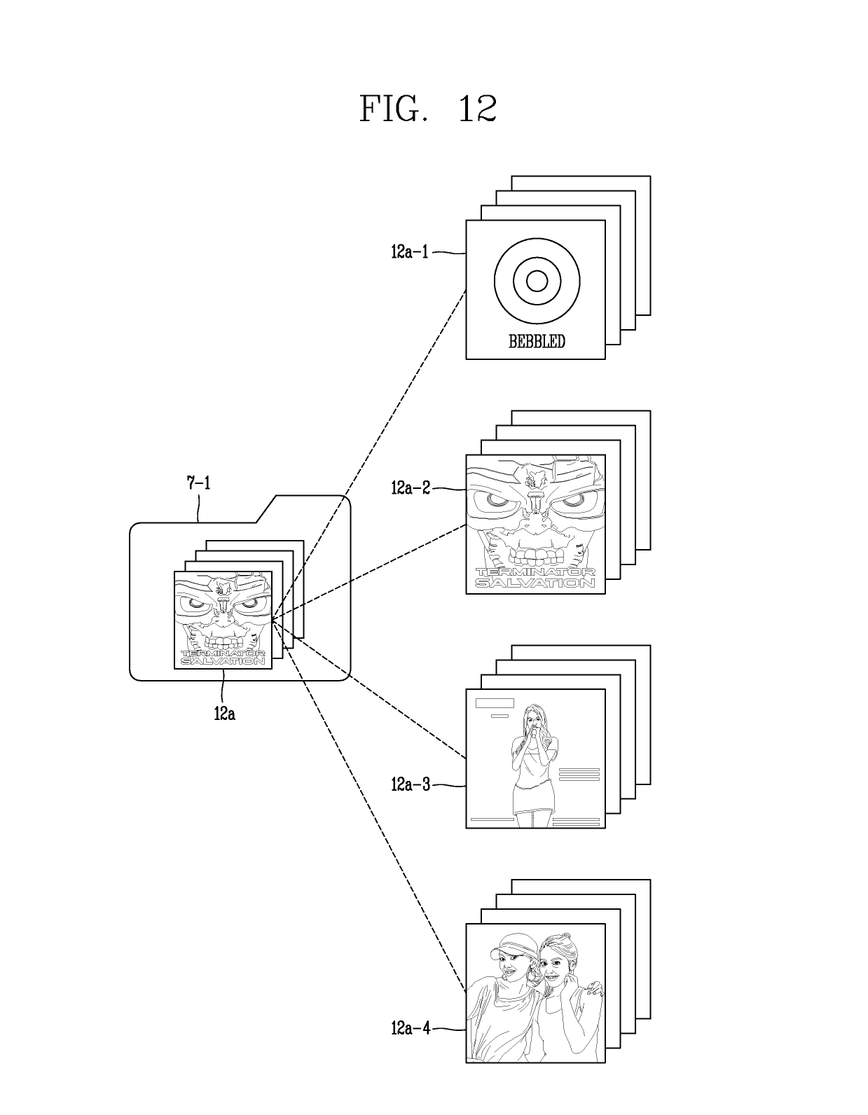

FIG. 12 illustrates images displayed on a folder according to one embodiment.

With reference to FIG. 12, when the content items selected by the user are automatically stored in a folder 7-1, the controller 150 displays representative images (e.g., thumbnail images) 12a representing the content items stored in the folder 7-1 on the folder. The representative images 12a may be representative images that were previously set for the respective content items or may be representative images received from a corresponding server.

The controller 150 displays the representative images 12a such that portions of the representative images overlap. For example, the controller 150 may display the representative images such that portions of the representative images overlap, in order, starting from either a content item which has been most recently used or a content item which has been most frequently used, among the content items of the folder 7-1.

The representative images 12a displayed on the folder 7-1 may include representative images (e.g., thumbnail images) 12a-1 each representing application programs, representative images (e.g., thumbnail images) 12a-2 each representing video files, representative images (e.g., thumbnail images) 12a-3 each representing music files, and representative images (e.g., thumbnail images) 12a-4 each representing photo files. The representative images may be still images or video images.

With reference back to FIG. 11, the controller determines whether a particular representative image is selected from among the representative images 12a (S23). For example, in a state in which the pointer 101 is positioned on the folder, a selection may be made according to a signal input via a direction key, a wheel scroll, etc., of the external input device 200. In this regard, the controller 150 may sequentially change a display order of the representative images displayed on the folder 7-1 according to the signal that is input. Also, the selection of the particular representative image may be made according to a touch-and-drag operation performed on the folder 7-1. In this regard, the controller 150 may sequentially change a display order of the representative images displayed on the folder 7-1 when the touch-and-drag operation is performed.

When a particular representative image is selected from among the representative images 12a each representing the content items of the folder 7-1, the controller 150 reproduces (or plays) a preview image of a content item corresponding to the selected particular representative image at a display position of the selected particular representative image (S24). For example, when the pointer 101 is positioned on a representative image 12a-2 representing a video file, the controller 150 reproduces a preview image of the video file corresponding to the selected representative image instead of the representative image. As another example, when the pointer 101 is positioned on a representative image 12a-3 representing a music file, the controller 150 reproduces a preview image (e.g., an image indicating that the music is being reproduced) of the music file corresponding to the selected representative image instead of the representative image, and, at the same time, reproduces the music file.

According to one embodiment, when a touched state of the representative image 12a-2 representing the video file is maintained, the controller 150 may reproduce the preview image of the video file corresponding to the selected representative image instead of the representative image. According to one embodiment, when a touched state of the representative image 12a-3 representing the music file is maintained, the controller 150 may reproduce the preview image (e.g., an image indicating that the music is being reproduced) of the music file corresponding to the selected representative image instead of the representative image, and at the same time, reproduce the music file.

After a particular representative image is selected from among the representative images 12a, the controller 150 determines whether a request signal for requesting execution of a content item corresponding to the selected particular representative image is received (S25). For example, the controller 150 determines whether a particular button (e.g., an OK key) of the external input device 200 is selected during a state in which the pointer 101 is positioned on the representative image 12a-2 representing the video file. As additional examples, the controller determines whether the representative image 12a-2 representing the video file is long-touched or double-touched.

When the request signal for requesting execution of the content item corresponding to the selected particular representative image is received, the controller 150 executes the content item corresponding to the selected particular representative image (S26). For example, during a state in which the pointer 101 is positioned on the representative image 12a-2 representing the video file, when the particular button (e.g., the OK key) of the external input device 200 is selected, the controller 150 executes (reproduces) the video file on the display unit 170. Also for example, when the representative image 12a-2 representing the video file is long-touched or double-touched, the controller 150 executes (reproduces) the video file on the display unit 170.

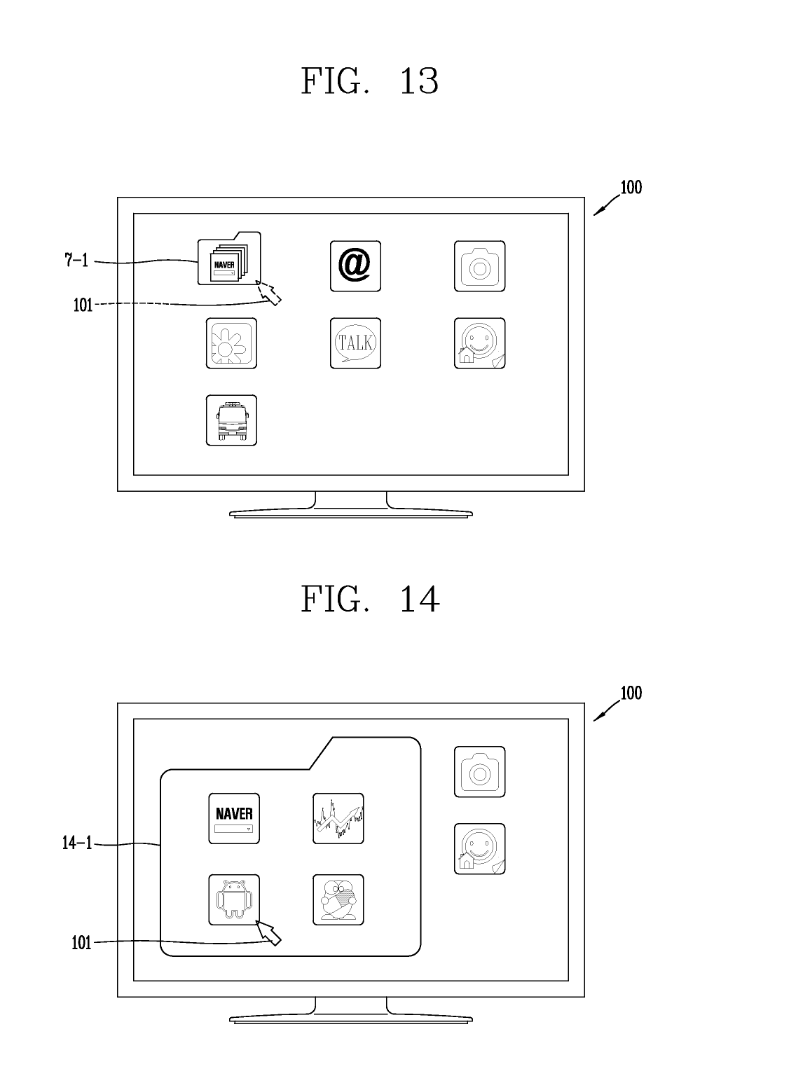

FIGS. 13 and 14 illustrate executing content within a folder according to one embodiment.

With reference to FIG. 13, when the folder 7-1 is selected, the controller 150 automatically magnifies (or enlarges display of) the folder 7-1 and the content items (representative images) of the folder 7-1. For example, with reference to FIG. 14, the controller 150 displays folder 14-1 corresponding to the selected folder 7-1. During a state in which the selecting of the folder 7-1 is maintained, when the maintaining of a selecting of a particular content item (e.g., a content item corresponding to a particular representative image) of the folder 7-1 is terminated, the controller 150 may execute the particular content item. For example, when the folder 7-1 is selected by the pointer 101, the controller 150 automatically magnifies the folder 7-1 and the content items (representative images) of the folder 7-1 together (see, e.g., FIG. 14). During a state in which the selecting of the folder 7-1 is maintained, when a selecting by the pointer 101 of a particular content item (e.g., a content item corresponding to a particular representative image) of the folder 7-1 is terminated, the controller 150 executes the particular content item corresponding to a point at which the selecting by the pointer 101 has been terminated.

When the folder 7-1 is touched (touch start), the controller 150 automatically magnifies the folder 7-1 and the content items (the representative images) of the folder 7-1 together, and during a state in which the touch applied to the folder 7-1 is maintained, when the touch on the particular content item (e.g., the content item corresponding to a particular representative image) of the folder 7-1 is terminated (touch release), the controller 150 may execute the particular content item corresponding to the point at which the touch has been terminated.

Thus, according to a content control apparatus and a method of operating the content control apparatus of embodiments of the present invention, content items are displayed on a folder and a content item may be selected from the folder, to allow a user to easily and quickly execute the content item.

As described earlier, according to the content control apparatus and the method of operating the content control apparatus of embodiments of the present invention, when content items are selected by the user, a folder is automatically generated and the selected content items are automatically stored (displayed) in the generated folder, such that content items desired by the user can be easily and quickly stored (displayed) in the folder.

According to the content control apparatus and the method of operating the content control apparatus of embodiments of the present invention, when the user selects a folder in which selected content items are stored (displayed), all the content items of the folder are automatically retrieved and displayed, such that the user can quickly and easily retrieve the content items of the folder.

According to the content control apparatus and the method of operating the content control apparatus of embodiments of the present invention, content items are displayed on a folder, and a content item is selected from the folder, such that a user can easily and quickly execute the content items of the folder.

With regard to configurations and operating methods, embodiments of the present invention are not limited to the embodiments described herein. It is understood that embodiments (or portions thereof) can be selectively combined to configure various modifications.

As embodiments of the present invention may be implemented in several forms without departing from the spirit thereof, it should also be understood that embodiments are not limited by any of the details of the foregoing description, unless otherwise specified, but rather should be construed broadly within their scope as defined in the appended claims. Therefore, it is intended that various changes and modifications that fall within the scope of the claims, or equivalents thereof, are covered by the appended claims.

What is claimed is:

1. A content control apparatus comprising:
a display unit configured to display a plurality of content items; and
a controller configured to:
generate a grid for setting a plurality of regions when an editing event occurs;
display the grid on the display unit, such that each of the plurality of content items is displayed at a region of the plurality of regions;
automatically generate a folder when it is determined that one or more regions of the plurality of regions are selected, wherein one or more content items of the plurality of content items are displayed at the selected one or more regions;
store the one or more content items in the generated folder; and
automatically retrieve the stored one or more content items from the generated folder and concurrently delete the generated folder when an event for retrieving the stored one or more content items from the generated folder occurs,
wherein the controller is further configured to display information regarding folder editing on the display unit when the grid is selected.

2. The content control apparatus of claim 1, wherein the controller is further configured to:
detect a common category of the one or more content items stored in the generated folder; and
automatically set a title corresponding to the common category as a name of the generated folder.

3. The content control apparatus of claim 1, wherein the controller is further configured to:
detect categories of the one or more content items stored in the generated folder;
select a category having a largest detection occurrence from among the detected categories; and
automatically set a title corresponding to the selected category as a name of the generated folder.

4. The content control apparatus of claim 1, wherein the controller is further configured to automatically arrange a display of the retrieved one or more content items on the display unit.

5. The content control apparatus of claim 1, wherein the information comprises user instructions regarding setting a region for selecting content items, generating the folder, and deleting the folder.

6. The content control apparatus of claim 1, wherein when a content item is selected from the plurality of content items displayed on the display unit and a pre-set event for generating the folder occurs, the controller generates the folder and displays the generated folder at a display position of the selected content item, and stores the selected content item in the generated folder.

7. The content control apparatus of claim 1, wherein, when the one or more content items are stored in the generated folder, the controller displays one or more representative images, each of the one or more representative images representing a respective one of the one or more content items, such that portions of the one or more representative images overlap.

8. The content control apparatus of claim 7, wherein the controller changes a display position of each of the one or more representative images according to a user input.

9. The content control apparatus of claim 7, wherein, when a particular representative image is selected from the one or more representative images, the controller reproduces a preview image of content corresponding to the selected particular representative image on the generated folder.

10. The content control apparatus of claim 9, wherein, when the controller receives a signal for requesting execution of the content corresponding to the selected particular representative image, the controller executes the content corresponding to the selected particular representative image in response to the received signal.

11. A method of operating a content control apparatus, the method comprising:
displaying, by a display unit of the content control apparatus, a plurality of content items;
generating a grid for setting a plurality of regions when an editing event occurs;
displaying, by the display unit, the generated grid such that each of the plurality of content items is displayed at a region of the plurality of regions;
automatically generating a folder when it is determined that one or more regions of the plurality of regions are selected, wherein one or more content items of the plurality of content items are displayed at the selected one or more regions;
storing the one or more content items in the generated folder;
automatically retrieving the stored one or more content items from the generated folder when an event for retrieving the stored one or more content items from the generated folder occurs; and
displaying, by the display unit, information regarding folder editing when the grid is selected.

12. The method of claim 11, further comprising:
detecting a common category of the one or more content items stored in the generated folder; and
automatically setting a title corresponding to the common category as a name of the generated folder.

13. The method of claim 11, further comprising:
detecting categories of the one or more content items stored in the generated folder;
selecting a category having a largest detection occurrence from among the detected categories; and
automatically setting a title corresponding to the selected category, as a name of the generated folder.

14. The method of claim 11, further comprising:
automatically arranging a display of the retrieved one or more content items on the display unit.

15. The method of claim 11, wherein the information comprises user instructions regarding setting a region for selecting content items, generating the folder, and deleting the folder.

16. The method of claim 11, further comprising:
when a content item is selected from the plurality of content items displayed on the display unit and a pre-set event for generating a folder occurs, generating the folder at a display position of the selected content item; and
storing the selected content item in the generated folder.

17. The method of claim 11, further comprising:
when the one or more content items are stored in the generated folder, displaying one or more representative images, each of the one or more representative images representing a respective one of the one or more content items on the folder, such that portions of the one or more representative images overlap.

18. The method of claim 17, further comprising:
changing a display position of each of the one or more representative images according to a user input.

19. The method of claim 17, further comprising:
when a particular representative image is selected from the one or more representative images, reproducing a preview image of the content item corresponding to the particular representative image on the folder.

20. The method of claim 19, further comprising:
receiving a signal for requesting execution of the content item corresponding to the selected particular representative image; and
executing the content item corresponding to the selected particular representative image in response to the received signal.

21. A content control apparatus comprising:
a display unit configured to display a plurality of content items; and
a controller configured to:
automatically generate a folder when it is determined that a region including one or more content items among the displayed plurality of content items is selected;
store the one or more content items included in the generated folder;
detect categories of the stored one or more content items;
determine a name of the generated folder based on the detected categories;
automatically display the determined name of the folder on the generated folder;
arrange the categories of the stored one or more content items according to priority;
display titles corresponding to the arranged categories on the generated folder; and
when a title of the titles corresponding to the arranged categories is selected, change the name of the generated folder to the selected title.

22. The content control apparatus of claim 21, wherein the controller is further configured to set a category having a highest detection occurrence or a highest frequency of usage from among the detected categories as the name of the generated folder.

23. The content control apparatus of claim 21, wherein the controller is further configured to:
arrange the categories of the stored one or more content items in order, starting from a category having a highest detection occurrence or a highest frequency of usage;
determine the arranged categories as folder names; and
display a folder name list including the folder names together with the determined name of the generated folder.

24. The content control apparatus of claim 21,
wherein the controller is further configured to:
when it is determined that a region for selecting a particular content item of the plurality of content items and a particular folder is selected, automatically generate a new folder, store the particular content item and the particular folder in the generated new folder, and automatically set a category having a highest frequency of usage or having a highest detection occurrence from among the categories of the stored content items and the particular folder, as a name of the generated new folder.

25. The content control apparatus of claim 21, wherein the controller is further configured to:
when it is determined that a region for selecting a first folder and a second folder is selected, automatically generate a new folder, store the first folder and the second folder in the generated new folder, and automatically set a category having a highest frequency of usage or having a highest detection occurrence from among the categories of content items stored in the first folder and the second folder, as a name of the generated new folder.
